(19) United States
(12) Patent Application Publication
(10) Pub. No.: US 2007/0167189 A1
(43) Pub. Date: Jul. 19, 2007

(54) Specification safety cap with MP3 play function

(76) Inventor: Chi-Ching Liu, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/589,246

(22) Filed: Oct. 30, 2006

(30) Foreign Application Priority Data
Dec. 23, 2005 (TW) 94222547

(51) Int. Cl. H04M 1/00

(52) U.S. Cl. 455/556.1

(57) ABSTRACT

A safety cap with MP3 play function includes a safety cap, a MP3 play device, a card read device, an audio output device, a power supply system and a tact switch. The MP3 play device is mounted inside the safety cap. The card read device is mounted inside the safety cap and connects the MP3 play device. The audio output device is mounted inside the safety cap and connects the MP3 play device. The power supply system is mounted on the safety cap and connects the MP3 play device. The tact switch is mounted inside the safety cap and connects the MP3 play device. The safety cap with MP3 play function is convenient for a user to listen to MP3 music when riding a motorcycle and to expand storage capacity of MP3 music files.

### BACKGROUND OF THE INVENTION

1. Field of the invention

The present invention relates to a safety cap, and more especially to a safety cap with MP3 play function.

2. Description of the prior art

MP3 (MPEG Audio Layer3) is an efficient compression technology based on high fidelity, which uses special data compression algorithms to process original audio signals, thereby to create digital audio files one tenth their original size with unchanged music quality which is the same as the CD's. So MP3 players are widely used by people on the market.

As we have known, people must wear safety caps when they ride motorcycles. At this moment, if a user wants to listen to music, as shown in FIG. 1, since a prior MP3 player 10 need connect earphones 11, he must put the earphones in his ears before listening to MP3 music, then wear the safety cap and ride a motorcycle. However, the prior MP3 player 10 directly extends wires 12 of the earphones 11 to the ears of the user, so it is easy to cause the user to be drawn by the wires and the earphones 11 to fall off from the ears and when the wind becomes greater, the earphones is easy to be blown away. Furthermore, when the user is riding, the exposed earphones would produce wind shear sound under the influence of wind speed, which causes poor sound quality of the MP3 player 10. Thirdly, with the advancement of technologies, the MP3 player 10 is smaller and smaller and can be put in a pocket of clothes and trousers or a bag of the user. However, when being put in the pocket, the MP3 player 10 is easy to be pressed and damaged.

Hence, inventors of the present invention have this idea that the shortages above are able to be improved and finally suggest the present invention which is a reasonable design and an effective improvement basing on deep research.

### SUMMARY OF THE INVENTION

A object of the present invention is to provide a safety cap with MP3 play function which is convenient for a user to listen to MP3 music when riding a motorcycle, can prevent the user from being drawn by exposed wires, avoid that wind shear produced under the influence of wind speed causes poor sound quality of the MP3 music files and let the user expand storage capacity of MP3 music files himself, and includes a power supply system for supplying necessary power.

To achieve the above-mentioned object, a safety cap with MP3 play function in accordance with the present invention is disclosed. The safety cap with MP3 play function includes a safety cap, a MP3 play device mounted inside the safety cap, a card read device mounted inside the safety cap and connecting the MP3 play device, an audio output device mounted inside the safety cap and connecting the MP3 play device, a power supply system mounted on the safety cap and connecting the MP3 play device and a tact switch mounted inside the safety cap and connecting the MP3 play device.

To further understand technical contents, methods and efficacy of the present invention, please refer to the following detailed description and drawings related the present invention. It is believed that the objects, features and points of the present invention can be deeply understood. But the drawings are only used to be references and explanations, not be limits to the present invention.

### BRIEF DESCRIPTION OF THE DRAWINGS

FIG. 1 is a perspective view of a prior MP3 player;

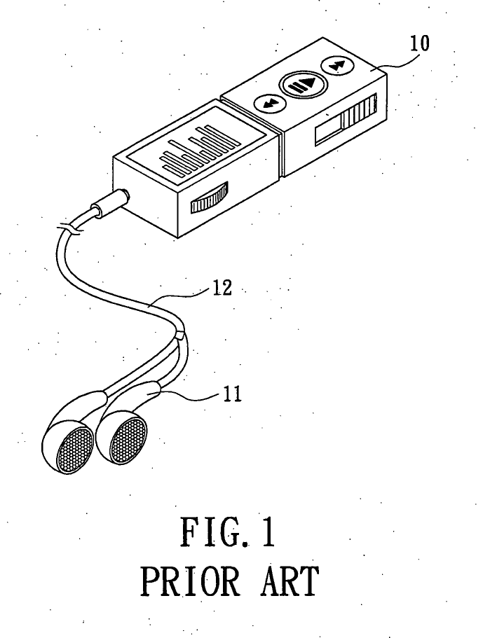

FIG. 2 is a perspective view of a safety cap with MP3 play function in accordance with the present invention;

FIG. 3 is a circuit block diagram of the safety cap with MP3 play function in accordance with the present invention;

FIG. 4 is a perspective view of the safety cap with MP3 play function in accordance with the present invention, connecting a mobile phone process device;

FIG. 5 is a circuit block diagram of the safety cap with MP3 play function in accordance with the present invention, connecting a mobile phone process device.

### DETAILED DESCRIPTION OF THE INVENTION

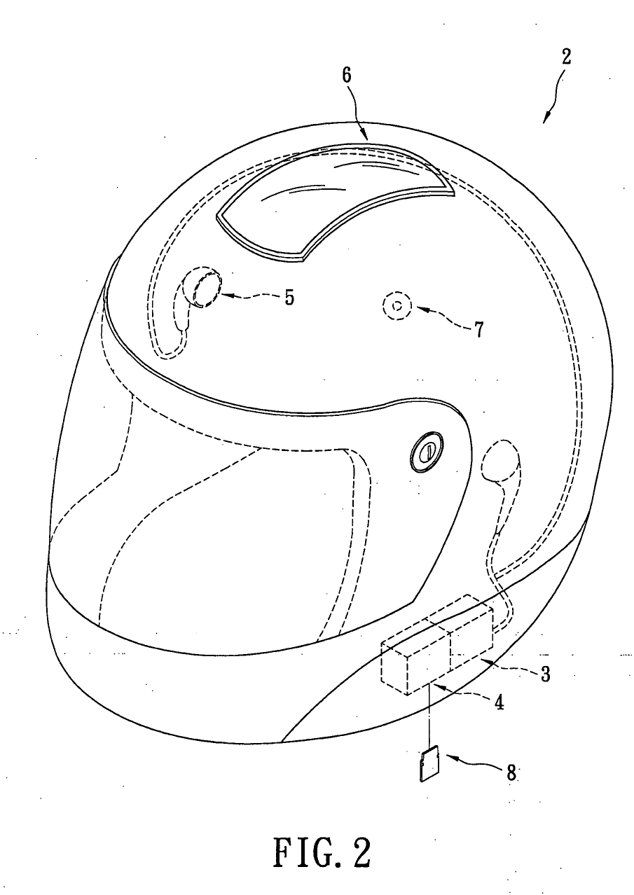

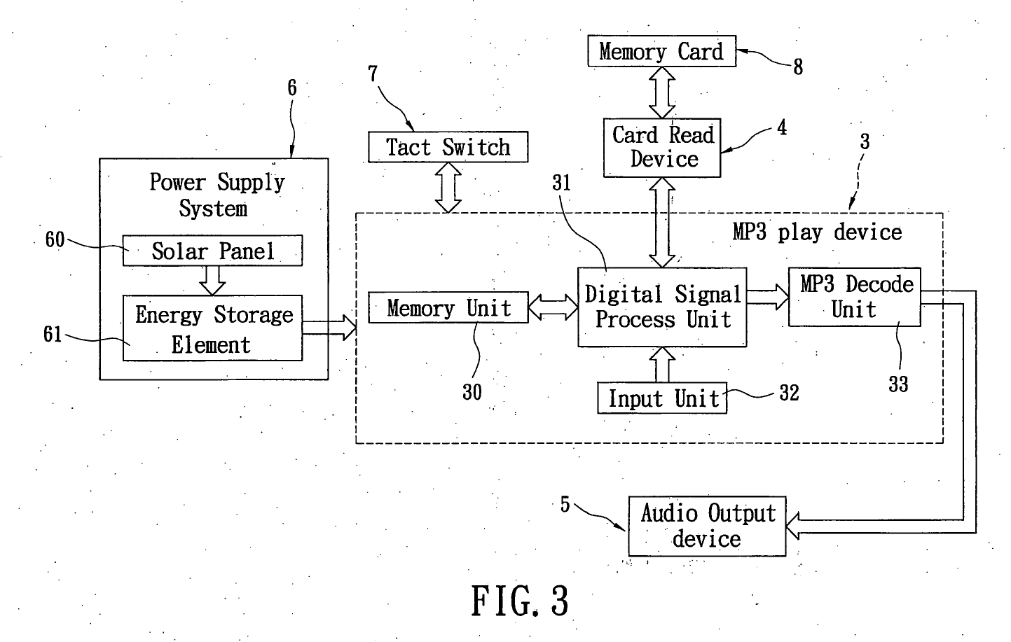

Please referring to FIGS. 2 and 3, a safety cap with MP3 play function in accordance with a preferred embodiment of the present invention includes a safety cap 2, a MP3 play device 3, a card read device 4, an audio output device 5, a power supply system 6 and a tact switch 7. In the preferred embodiment, the safety cap 2 is full-face style on the market. The MP3 play device 3 is mounted in a proper position inside the safety cap 2. The card read device 4 is mounted in a proper position inside the safety cap 2 and connects MP3 play device 3. The audio output device 5 is positioned at both the left and the right sides inside the safety cap 2, corresponding to use's ears. The power supply system 6 is arranged on the safety cap 2, or mounted at other proper positions (not shown). The power supply system 6 connects the MP3 play device 3 and supplies power therefor. The tact switch 7 is arranged in a proper position inside the safety cap 2 and connects the MP3 play device 3 to switch on/off the device 3.

The power supply system 6 has a solar panel 60 and an energy storage element 61. The power supply system 6 absorbs light energy from ordinary light sources or the sun and converts the light energy into electric energy through the solar panel 60, then stores the electric energy in the energy storage element 61, to supply necessary power for the MP3 play device 3. The energy storage element 61 can be one of reusable storage batteries, such as Ploymer Lithium Battery, Lithium Battery, Lithium Ion Battery, Nickel Hydrogen Battery and Nickel Cadmium Battery.

The card read device 4 may connect a memory card 8. The memory card 8 is movably inserted in the card read device 4 for expanding storage capacity. The memory card 8 can be one of MS (Memory Stick) card, CF (Compact Flash) card, SMC (Smart Media) card, MMC (Multi Media) card, RS-MMC (Reduced Size-Multi Media) card and SD (Secure Digital) card.

The MP3 play device 3 includes a memory unit 30, a digital signal process unit 31, an input unit 32 and a MP3 decode unit 33. The digital signal process unit 31 connects the memory unit 30, the input unit 32 and the MP3 decode unit 33. The card read device 4 connects the digital signal process unit 31. The audio output device 5 connects the MP3 decode unit 33. The digital signal process unit 31 processes digital signals. The memory unit 30 is controlled by the digital signal process unit 31 and stores digital data. The memory unit 30 can be a flash memory. The digital signal process unit 31 connects the card read device 4, controls the card read device 4 and accesses digital data on the memory card 8 in the card read device 4. The embodiment expands data storage capacity through the memory card 8, and the memory card 8 also can store a large amount of MP3 digital music file data.

The input unit 32 outputs a control signal to control the digital signal process unit 31, thereby realizing human-machine interface. Furthermore, the digital signal process unit 31 decodes the MP3 digital music files on the memory card 8 in the card read device 4 into voice signals, and then output the voice signals to the audio output device 5, thereby the user can listen to the MP3 music through the audio output device 5. In the above description, the audio output device 5 is an earphone.

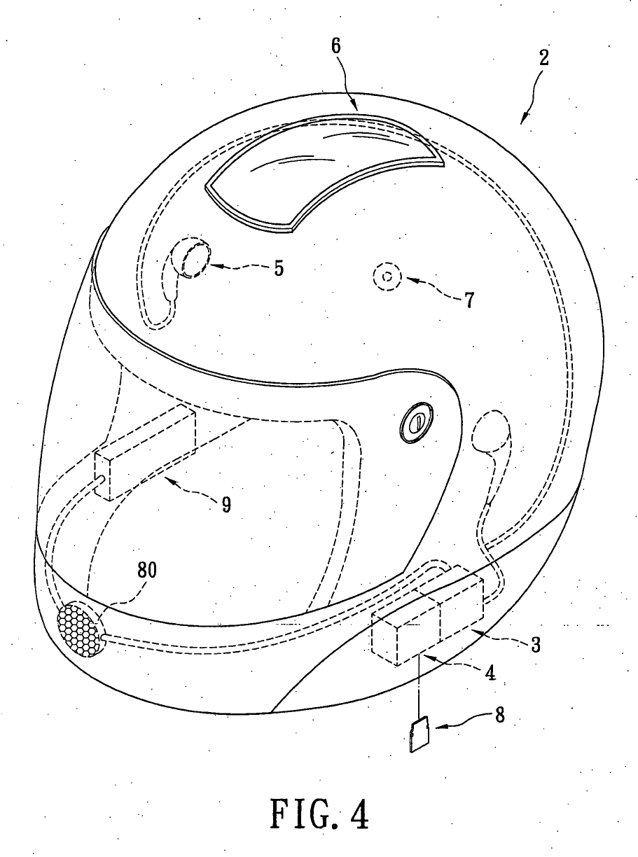

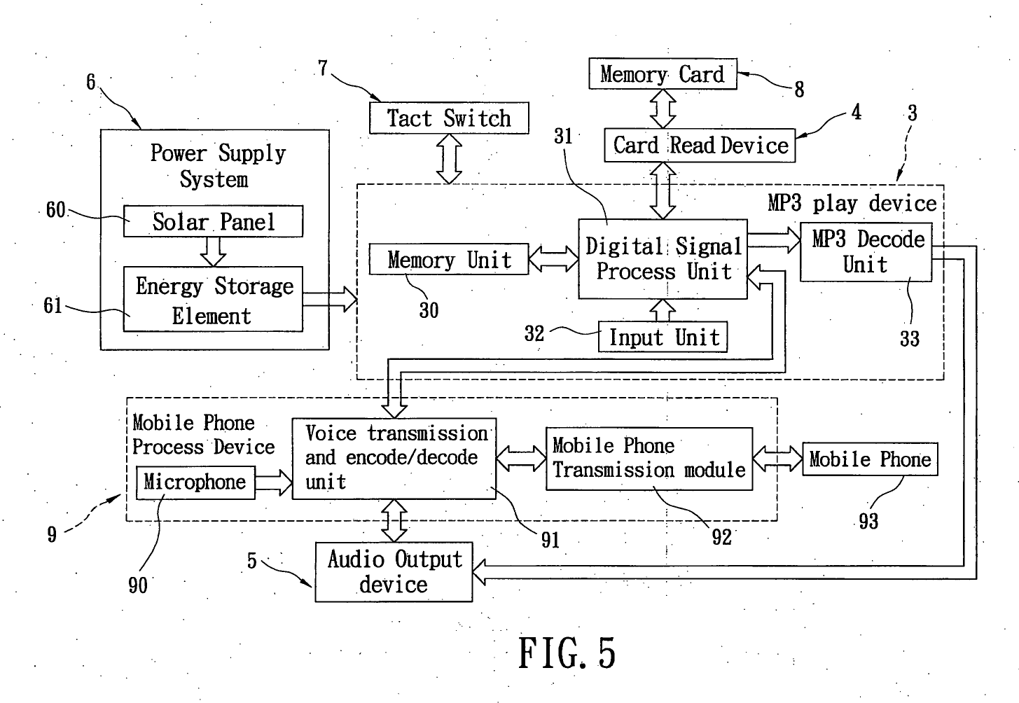

Please referring to FIGS. 4 and 5, the MP3 play device 3 and the audio output device 5 further connect a mobile phone process device 9. The mobile phone process device 9 is mounted in a proper position inside the safety cap 2, and includes a microphone 90, a voice transmission and encode/decode unit 91 and a mobile phone transmission module 92. The voice transmission and encode/decode unit 91 connects the microphone 90 and the mobile phone transmission module 92, and connects the digital signal process unit 31 and the audio output device 5. The voice transmission and encode/decode unit 91 encodes and decodes voice signals and convert signals between analog data and digital data. The mobile phone transmission module 92 can connect a mobile phone 93 to receive incoming signals from the mobile phone 93 and transmit modulated signals to the mobile phone 93. The incoming signals received by the mobile phone transmission module 92 are decoded by the voice transmission and encode/decode unit 91, processed by the digital signal process unit 31, and then transmitted to the audio output device 5 which connects the voice transmission and encode/decode unit 91 to be output.

At the same time, voice signals are transmitted to the voice transmission and encode/decode unit 91 via the microphone 90. The voice transmission and encode/decode unit 91 is controlled by the digital signal process unit 31 to encode data of the voice signals and then transmits the modulated signals to the mobile phone via the mobile phone transmission module 92. In the above description, the mobile phone transmission module 92 is a Bluetooth receiver or a terminal connection-peg.

When a call is coming, the mobile phone transmission module 92 receives the coming signal and transmits the coming signal to the voice transmission and encode/decode unit 91. The voice transmission and encode/decode unit 91 decodes the voice signal and transmits the decoded voice signal to the audio output device 5 under the control of the digital signal process unit 31. The audio output device 5 outputs the voice signal, thereby the user can hear what the other says clearly. Meanwhile, if the user is listening to MP3 digital music via the audio output device 5, the digital signal process unit 31 will interrupt the broadcast of MP3 digital music and control the use of the audio output device 5 firstly, in order that the user can receive the coming signal and answer the phone. After the call ends, the digital signal process unit 31 controls the use of the audio output device 5 and restores the interrupted broadcast of the MP3 digital music.

Simultaneously, the user transmits a voice signal to respond. The voice signal is transmitted via the microphone 90 to the voice transmission and encode/decode unit 91. After encoded by the voice transmission and encode/decode unit 91, the voice signal is transmitted to the mobile phone transmission module 92. The mobile phone transmission module 92 outputs a modulated signal to the mobile phone 93 to respond. Hence, the present invention, the safety cap with MP3 play function, achieves a function of answering a voice communication from the mobile phone 93 via the mobile phone process device 9.

In summary, the present invention can connect with a mobile phone via the mobile phone process device 9 for a voice communication with the mobile phone 93. Furthermore, the present invention can connect the MP3 decode unit 33 via the digital signal process unit 31. The MP3 decode unit 33 can decode the MP3 digital music files stored in the memory unit 30 into voice signals. Or the digital signal process unit 31 can control the card read device 4 to access the MP3 digital music files on the memory card 8 and control the MP3 decode unit 33 to decode the MP3 digital music files into voice signals. In the above description, the voice signals output by the MP3 decode unit 33 are transmitted to the audio output device 5 in order that the user can listen to the MP3 music.

Secondly, the present invention is supplied necessary power by the power supply system 6 which can charge itself. The energy storage element 61 has long service life and avoids being replaced frequently. If the present invention takes ordinary batteries on the market, the present invention need replace the batteries frequently, which brings a large number of waste batteries and causes a lot of environmental pollution. Through switching on/off the tact switch 7, the user can start the MP3 play device 3 when wearing the safety cap 2 or keep the MP3 play device 3 in closing state when not wearing the safety cap 2, so that electric energy waste is reduced

Moreover, when the user is riding a motorcycle and listening to MP3 music via the safety cap with MP3 play function, because the safety cap 2 arranges the MP3 play device 3 and the audio output device 5 in proper positions thereinside, it can be avoided that wind shear produced under the influence of wind speed causes poor sound quality of the MP3 music files. Since the MP3 play device 3 and the audio output device 5 are mounted inside the safety cap 2, there is no wire exposed outside, which prevents the user from being drawn by the wire, and there is no need to put any wire in use's pocket. And the present invention has the card read device 4 which is convenient for the user to insert the memory card 8 in for expanding storage capacity of MP3 music files.

What is disclosed above only is the preferred embodiment of the present invention it will be understood by those skilled in the art that various equivalent changes may be made depending on the specification and the drawings of present invention without departing from the scope of the present invention.

What is claimed is:

1. A safety cap with MP3 play function, comprising:
a safety cap;
a MP3 play device, mounted inside the safety cap;
a card read device, mounted inside the safety cap and connecting the MP3 play device;
an audio output device, mounted inside the safety cap and connecting the MP3 play device;
a power supply system, mounted on the safety cap and connecting the MP3 play device; and
a tact switch, mounted inside the safety cap and connecting the MP3 play device.

2. The safety cap with MP3 play function as claimed in claim 1, wherein the MP3 play device includes a memory unit, a digital signal process unit, an input unit and a MP3 decode unit, the digital signal process unit connects the memory unit, the input unit and the MP3 decode unit, the card read device connects the digital signal process unit, and the MP3 decode unit connects the audio output device.

3. The safety cap with MP3 play function as claimed in claim 2, wherein the memory unit is a flash memory.

4. The safety cap with MP3 play function as claimed in claim 2, wherein the MP3 play device and the audio output device further connect a mobile phone process device, and the mobile phone process device is mounted inside the safety cap.

5. The safety cap with MP3 play function as claimed in claim 4, wherein the mobile phone process device includes a microphone, a voice transmission and encode/decode unit and a mobile phone transmission module, the voice transmission and encode/decode unit connects the microphone and the mobile phone transmission module, and the voice transmission and encode/decode unit connects the digital signal process unit and the audio output device.

6. The safety cap with MP3 play function as claimed in claim 5, wherein the mobile phone transmission module connects a mobile phone, and the mobile phone transmission module is a Bluetooth receiver or a terminal connection-peg.

7. The safety cap with MP3 play function as claimed in claim 1, wherein the card read device connects a memory card and the memory card is movably inserted in the card read device.

8. The safety cap with MP3 play function as claimed in claim 7, wherein the memory card is MS (Memory Stick) card, CF (Compact Flash) card, SMC (Smart Media) card, MMC (Multi Media) card, RS-MMC (Reduced Size-Multi Media) card or SD (Secure Digital) card.

9. The safety cap with MP3 play function as claimed in claim 1, wherein the audio output device is an earphone.

10. The safety cap with MP3 play function as claimed in claim 1, wherein the power supply system has a solar panel and an energy storage element, the energy storage element is Polymer Lithium Battery, Lithium Battery, Lithium Ion Battery, Nickel Hydrogen Battery or Nickel Cadmium Battery.
